(19) United States
(12) Patent Application Publication
(10) Pub. No.: US 2007/0196542 A1
(43) Pub. Date: Aug. 23, 2007

(54) CONSUMABLE PRODUCT CONTAINER ASSEMBLY

(75) Inventors: Jon Rathbone, Wolfverhampton (GB); Katie Hernandez, Chicago, IL (US); Tyler Simpson, Chicago, IL (US)

Correspondence Address: BELL, BOYD & LLOYD LLP, P.O. Box 1135, CHICAGO, IL, 60690, US

(73) Assignee: WM. WRIGLEY JR. COMPANY, Chicago, IL (US)

(21) Appl. No.: 11/682,765

(22) Filed: Mar. 6, 2007

Related U.S. Application Data
(63) Continuation-in-part of application No. 11/234,496, filed on Sep. 23, 2005.

(51) Int. Cl. A23B 7/148

(52) U.S. Cl. 426/106

(57) ABSTRACT

A container is provided for dispensing a plurality of consumable products and can include a lid and a receptacle. The container may be portable and placed in various settings. The container may be sized and shaped to fit in a standard cup holder. The container may be configured to be opened intuitively and may dispense a large amount of products or a portion controlled amount of products from an interior. Defined in the container may be two dispenser openings of differing size where at least one of the dispenser openings can be used to share the consumable products with more than one consumer.

### PRIORITY CLAIM

This application is a continuation-in-part of U.S. patent application Ser. No. 11/234,496, filed on Sep. 23, 2005, the disclosure of which is incorporated herein by reference.

### BACKGROUND

The present invention relates generally to packaging. More particularly, the present invention relates to containers for storing and dispensing confectionery products.

The packaging for confectionery products is important to the marketing and storage of the product. As such, containers for confectionery products come in a variety of sizes, shapes and designs. For example, containers can be hand-held containers, with an openable lid for the dispensing of small, individual pieces of confectionery product. Such containers are traditionally useful for dispensing of one individual product, or a small number of individual products, at a time. Alternately, containers may be larger, with an openable lid for dispensing many pieces at once.

Traditional containers are useful for a number of purposes. In particular, traditional containers keep products fresh and free from contaminants. Additionally, where a product consists of a number of small pieces, traditional containers are useful for maintaining them in a restricted space for easy carrying. Where the containers are larger, they are useful for maintaining a large number of small pieces in a convenient, often decorative, manner.

Many traditional containers, however, do not adequately allow for easy removal of the product. For example, where the container is located in a high-traffic area, such as a reception area, it may be desirable to dispense a larger number of pieces at a time. If the opening in the container is too small, significant amounts of agitation may be necessary to dispense a large number of pieces. Similarly, if the opening in the container is too small for a consumer to use his or her hand to remove the pieces, the contents of the container may be spilled, or the consumer may become frustrated and give up.

In this regard, many traditional containers do not provide a consumer with the choice of removal of multiple pieces, or removal of a small number of pieces. When a consumer desires a small number of pieces where only a large opening is present it may become difficult to remove the pieces without spilling the contents. In these instances, the large opening is unnecessary and creates a burden on the consumer. Furthermore, a large opening may allow multiple consumers to inadvertently touch unwanted pieces of the product when trying to remove an individual piece, creating an unhygienic environment. It would therefore be useful to provide a container that allows the option of either removal of a large number of pieces or a small, individual piece.

Further, conventional containers are often manufactured using multiple pieces of material. For example, when several openings are found in the container, these openings require multiple covers for sealing the openings to maintain control and for preservation of the pieces. The need for multiple covers makes the processing of such containers costly and time-consuming, as each cover is likely individually manufactured.

The present invention solves the deficiencies of the prior art.

### SUMMARY

The present invention provides a container for dispensing a plurality of consumable products. The present invention also provides a container with increased capacity to help alleviate product outages. The container may be portable so as to be ready for use in different environments. The container can comprise a lid, a receptacle and design features therein which enable the container to be opened intuitively. The container is durable and stable and yet may be opened using a single hand. The container may dispense a large amount of products and/or a portion controlled amount of products from an interior.

The present invention also provides an apparatus for dispensing individual confectionery products. More particularly, the present invention provides a two-piece lid for a confectionery product container. The products in one embodiment are confectionery products. The teachings of the present invention, however, are not dependent upon the products being any particular type as long as the products can fit within and be dispensed by the product container lid described herein. The container herein, regardless of what product is being dispensed, is configured to be highly functional, as described.

The present invention provides in an embodiment, a container including a receptacle and a lid. The receptacle has an opening and an interior housing a plurality of solid consumable products, and the lid covers the opening and includes a top face which defines a plane that is at an angle with respect to a horizontal plane so as to create a sloped surface.

In an embodiment, the lid includes at least one opening.

In an embodiment, the lid includes at least two openings of differing sizes.

In an embodiment, the receptacle is sized and shaped to fit in a standard cup holder.

The present invention additionally provides in an embodiment a container including a receptacle and a removable lid. The receptacle has an opening and an interior for housing a plurality of consumable products and the lid covers the opening where at least a portion of the interior is visible through the lid.

In an embodiment, at least a portion of the lid is transparent.

In an embodiment, at least a portion of the lid is semi-transparent.

In an embodiment, the entire lid is either transparent or semi-transparent.

In an embodiment, the receptacle is opaque.

In an embodiment, the receptacle also includes a portion that allows a portion of the interior to be visible through the receptacle.

In a further embodiment, a container includes a receptacle defining an interior housing a plurality of consumable products where the receptacle includes a mouth, a bottom surface, and an ergonomic contour. The container also includes a lid for removably covering the mouth and having at least one opening. The height of the container from the bottom surface of the receptacle to the opening in the lid measures between about 3 inches to about 4.5 inches.

In an embodiment, the height of the receptacle from the bottom surface to the mouth measures between about 2.5 inches and about 3.5 inches.

In an embodiment, the receptacle is sized and shaped to fit in a standard cup holder.

In an embodiment, the receptacle has a shape selected from the group consisting of cubic, rectangular, pyramidal, cylindrical, conical and spherical.

In an embodiment, the ergonomic contour includes a concave taper having a radius of curvature between about 3 inches to about 5 inches.

In an embodiment, the receptacle has a diameter measuring between about 2 inches to about 3 inches at the mouth.

In a further embodiment, a method for marketing product housed in a container includes the steps of: (1) providing a container including an interior housing a plurality of consumable products, the container having a lid including a first opening and a second opening each for dispensing the products, wherein the first opening is smaller than the second opening; and (2) instructing the consumer to use the first opening for sharing the consumable products with more than one consumer.

In an embodiment, instructions are printed on the container.

In an embodiment, instructions are provided in a product insert.

In a further embodiment, a confectionery product container includes a receptacle housing a plurality of confectionery products where the receptacle includes a mouth. The container also includes a lid for removably covering the mouth having at least two separate openings of differing sizes. The lid includes threads so as to be received on the receptacle via a twisting action.

In a further embodiment, a consumable product container includes a receptacle housing a plurality of solid consumable products where the receptacle includes a mouth. The receptacle is sized and shaped to fit in a standard cup holder. The container also includes a lid for removably covering the mouth having at least two separate openings.

In a further embodiment, a container includes a lid and a receptacle where the receptacle houses a plurality of solid consumable products. The receptacle has a bottom surface and a first ergonomic contour. The first ergonomic contour is substantially oblong in shape and has a width between about a half inch to about an inch and is disposed perpendicularly to a vertical axis passing through a center of the bottom surface. The lid covers an opening in the receptacle.

In an embodiment, the first ergonomic contour has a length of at least half of the receptacle's circumference.

In an embodiment, the receptacle includes a second ergonomic contour disposed perpendicularly to the axis.

In a further embodiment, a container includes a first housing and second housing. The housings define an interior containing a plurality of solid consumable products. The first housing is biased with respect to the second housing via a spring. A first opening can be defined by the container. The first opening provides access to the interior upon activation of the spring. A second opening can be defined by one of the first and second housings. The second opening also provides access to the interior.

In an embodiment, the spring biases the first housing in a closed position with respect to the second housing.

In an embodiment, the spring biases the first housing in an open position with respect to the second housing.

In an embodiment, the second opening is larger than the first opening.

In an embodiment, the second opening is smaller than the first opening.

In an embodiment, the second opening provides access to the interior via a hinge.

In an embodiment, the first housing is a lid and the second housing is a receptacle.

In an embodiment, the first housing is an inner housing and the second housing is an outer housing.

In a further embodiment, a two-piece lid for a confectionery product container is disclosed. The lid comprises a base and a single cover. The lid provides ease in dispensing of products, as well as ease in manufacturing.

In an embodiment, a two-piece lid includes a base and a single cover. The base of the lid has at least two openings of differing size.

In an embodiment, a confectionery product container has a receptacle for the storage of confectionery products and a two-piece lid. The lid preferably comprises a base with at least two openings of differing sizes and a single cover.

In an embodiment, one opening of the base is utilized for dispensing of a large number of individual confectionery products, and another opening is utilized for dispensing a small number of products.

In an embodiment, the cover is made of a single piece of material, separated into portions to cover the at least two openings.

In another embodiment, the cover comprises two portions connected by a hinge.

In an embodiment, the two portions of the cover are positioned in planes differing from one another.

In an embodiment, a cam is present to bias at least one portion of the cover in an open position.

In another embodiment, the confectionery product container is ajar.

In yet another embodiment, at least one opening in the base is angled. This angled shape maximizes the size of the opening.

In another embodiment, the cover is connected to the base by at least one hinge connection, at least one snap-fit connection, or combinations thereof.

It is therefore an advantage of the present invention to provide a container with an increased capacity for consumable products to alleviate outages and to reduce packaging.

It is also an advantage of the present invention to provide a stable container which may not easily be tipped.

It is another advantage of the present invention to provide a durable container that may resist spills and unwanted opening.

It is a further advantage of the present invention to provide a portable container that can be placed in various settings.

It is still another advantage of the present invention to provide a container that permits easy removal of products from the first piece to the last piece.

Moreover, it is advantage of the present invention to provide a container for consumable products that is intuitive and easy to open.

It is yet another advantage of the present invention to provide a container that may be opened using only one hand.

It is also an advantage of the present invention to provide a product container for dispensing individual products.

It is a further advantage of the present invention to provide a product container that is compact and easily stored.

It is yet another advantage of the present invention to provide a product container that is stable and able to fit into standard cup holders.

Moreover, it is an advantage of the present invention to provide a product container that is controllable to dispense only a desired amount of product.

Yet further, it is an advantage of the present invention to provide a receptacle lid that is manufactured in two pieces to improve molding efficiency.

Still further, it is an advantage of the present invention to provide a receptacle lid that allows a product to be dispensed via reach-in access or shaking.

Additional features and advantages are described herein, and will be apparent from, the following Detailed Description and the figures.

### BRIEF DESCRIPTION OF THE FIGURES

FIG. 1 illustrates a perspective view of one embodiment of the two-piece lid of the present invention.

FIG. 2 illustrates a side cross-section view of the embodiment of the two-piece lid of FIG. 1.

FIG. 3 illustrates a perspective view of the embodiment of the two-piece lid of FIG. 1, where the cover is removed from the base of the lid.

FIG. 4 illustrates a bottom perspective view of the two-piece lid of FIG. 1, where the cover is removed from the base of the lid.

FIG. 5 illustrates a perspective view of a one-piece lid embodiment of the present invention.

FIG. 6 illustrates a perspective view of a push-button lid embodiment of the present invention in an open position.

FIG. 7 illustrates a perspective side view of another push-button lid embodiment.

FIGS. 8 through 14 illustrate perspective views of various embodiments of the receptacle of the present invention.

FIGS. 15A and 15B illustrate perspective views of one embodiment of the consumable product container of the present invention in an open position and closed position respectively.

FIGS. 16A through 25C illustrate further embodiments of the consumable product container from a closed position to an open position.

### DETAILED DESCRIPTION

The present invention provides a consumable product container including a receptacle and a lid. Although in the embodiments illustrated the consumable products are illustrated as tablets of products, it will be understood that the products to be dispensed can be of any suitable shape and size. Examples of such shapes include pill, block, flat stick, pillow, round, rectangular, triangular, and any combination of same.

The container receptacle and lid in the embodiments described below are generally made of a plastic material. In an embodiment, the material is polyethylene or polypropylene. The present invention expressly includes, however, the receptacle and lid being made of any suitable material. In an embodiment, the container is sized and shaped to conveniently fit into a standard cup holder. However, it will be appreciated that the receptacle and lid illustrated in the embodiments are not expressly limited to any particular size or shape.

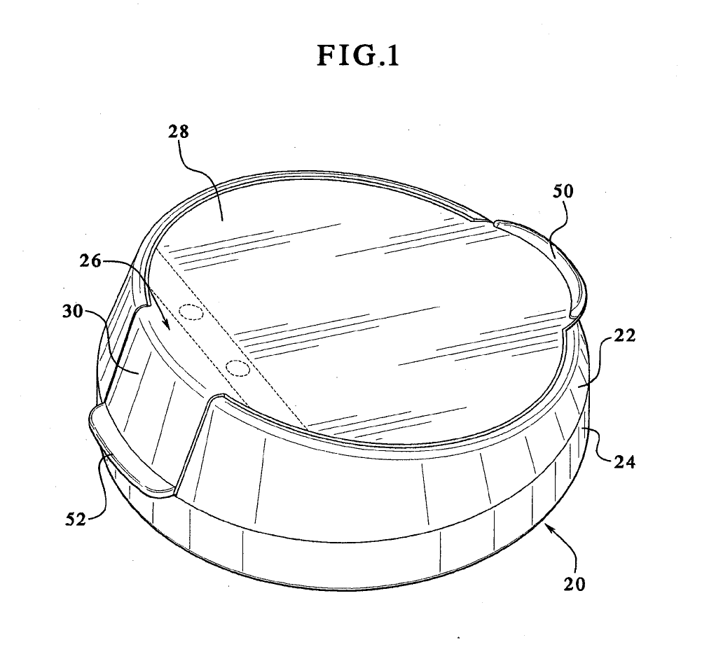

Referring now to the drawings, and in particular to FIG. 1, one embodiment of a lid for the dispensing of a consumable product is illustrated as lid 20. The lid 20 generally comprises two pieces: a base 22 and a cover 26. As illustrated further below, both the base 22 and the cover 26 can be organized into portions, while maintaining their unitary structures and maintaining the two-piece construction of the lid. For example, the base 22 may comprise a skirt portion 24, while the cover may comprise a major portion 28 and a minor portion 30.

The shape of the base 22 of the lid 20 illustrated in FIGS. 1 to 4 is generally oval or circular. It should be appreciated that the base 22 can be shaped in order to configure with the shape of the receptacle or of the opening of the receptacle. The receptacle may be any suitable size or shape, including but not limited to cubic, rectangular, pyramidal, cylindrical, conical and spherical. The receptacle defines an opening which enables the consumable products to be dispensed or otherwise removed from the receptacle.

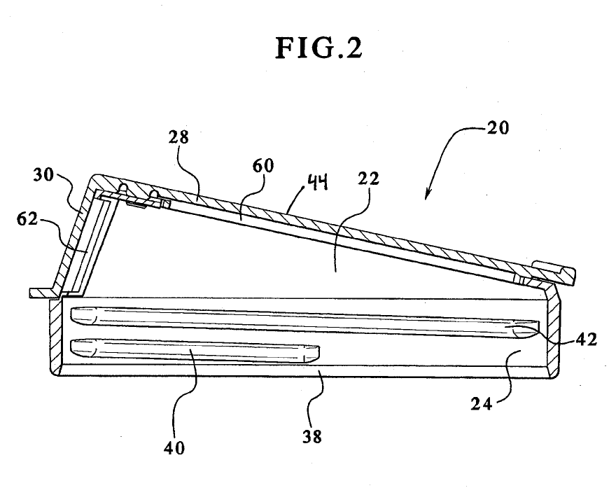

In one embodiment, illustrated in FIG. 2, the lid contains threads 40, 42, so as to fit with a receptacle via a twisting action. The threads may also be present around the opening of the receptacle. In an embodiment, the threads include a cooperating pair of single threads. Providing a long single thread on the lid and a long single thread on the receptacle can insure that there is: (a) only one starting point at which the lid starts twisting with respect to the receptacle (i.e. where the threads meet), and (b) only one ending point at which the lid stops twisting with respect to the receptacle (i.e. where the threads end). This way, a label on the lid and a label on the receptacle may be positioned with respect to the threads in a specific orientation that will insure that when the lid stops twisting around the receptacle, the labels on the lid and the receptacle will be appropriately aligned with respect to one another. In another embodiment, the threads may include more than one cooperating set of threads. In other words, the lid can include more than one thread 40, 42 and the receptacle can include more than one thread as well.

In another embodiment, the lid is manufactured so as to be snap-fit with the receptacle. In a further embodiment, the lid is manufactured so as to fit with the receptacle in a friction-fit. It will be appreciated that the lid 20, may be removably attached to a receptacle via any known means. In an alternate embodiment the lid 20 is permanently attached to, or integral with, the receptacle.

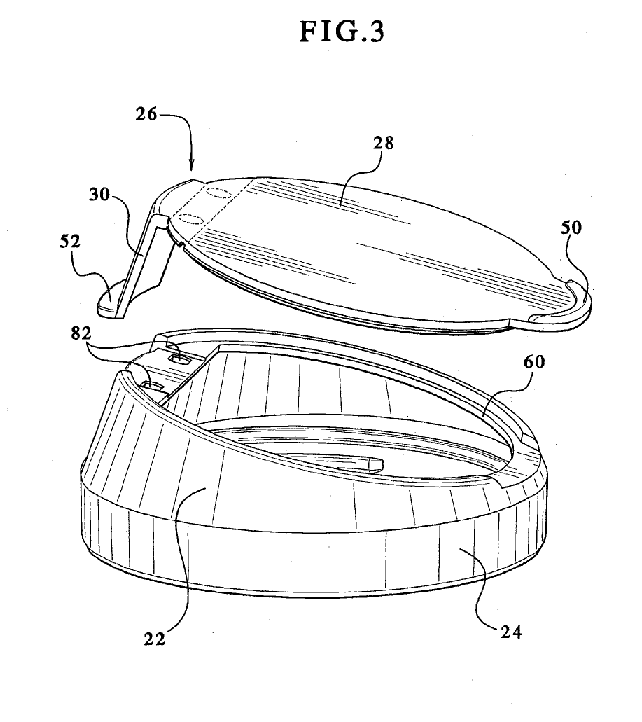

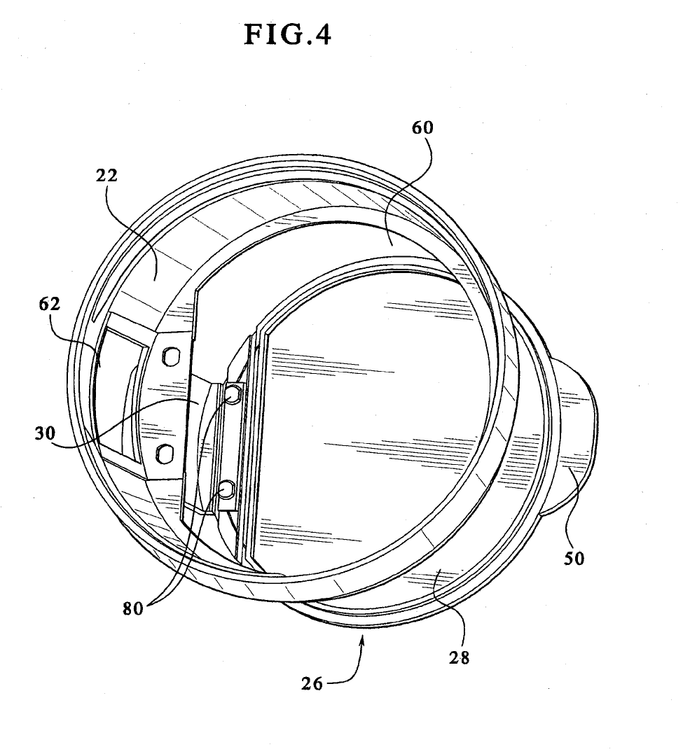

As illustrated in FIGS. 3 and 4, the base 22 preferably defines a major opening 60 and a minor opening 62. These openings are of differing sizes to allow for the removal of the products from the container in differing manners. In an embodiment, the major opening 60 and the minor opening 62, and their corresponding cover portions 28 and 30, are located in different planes relative to each other. It will be appreciated that any number and size of openings and corresponding cover portions may be present in the lid 20 of the present invention.

In an embodiment, as illustrated in FIGS. 1-4, the base 22 and by extension the major opening 60 is angled. In particular, as best seen in FIG. 2, the base 22 has a top face 44 defining a plane that is at an angle with respect to a horizontal plane so as to create a sloped surface. In an embodiment, the top face 44 is sloped with respect to a horizontal plane at an angle between about 10° and about 15°, for example about 12°. However, the angle can also include any angle between 1° and 89°. The major opening 60 lies in a plane that is parallel to a plane of the top face 44. This allows the size of the major opening 60 to be increased, meaning the size of the opening 60 on a sloped plane is made larger than a planar opening would allow. Additionally, the angled base 22 provides better viewing for labeling of the product. That is, a label can be applied to the top face for increased visibility to a consumer from a front view of the container. The major opening 60 provides easy reach-in access to the consumable products, and, therefore, easy removal of a large number of products at once. As illustrated, angling the major opening 60 may require elevating one end of the base 22, creating a wedge-type shape in the base 22.

In an embodiment, a minor opening 62 is defined by the base 22. As illustrated in FIGS. 3 and 4, particularly where the base is wedge-shaped to accommodate an angled major opening 60, the minor opening 62 may be located on the side of the base 22. The minor opening 62 is preferably sized to allow for dispensing of individual or a small number of products. Preferably, the minor opening 62 allows for the products to be shaken from the container, which provides ease of removal as well as prevents multiple consumers from touching the remaining product. In this way, the products can be hygienically dispensed from the container to multiple consumers. The presence of both a major opening 60 and a minor opening 62 allows differing quantities of products to be removed from the container in different ways.

Referring now specifically to the embodiment illustrated in FIG. 3, the cover 26 is sized and shaped to fit on or over the openings defined by the base 22. The cover 26 may frictionally engage the base 22, and may include a flange or tab 50, 52 for securing the cover 26 to the base 22. A consumer grabs or holds the tab 50, 52 and places force against it to secure the cover 26. The tab 50, 52 may be any suitable size and shape. An optional lip 38 may also be present on the base 22 for securing the cover 26 to the base 22. In an embodiment, a cam is additionally present to maintain a portion of the cover 26 in an open position. It will be appreciated that any other manner of securing the cover to the base may be utilized. In an embodiment, the cover may be connected to the base by at least one welded connection.

Preferably, the base portion 22 and cover 26 comprise two separate pieces of material. This configuration is present, regardless of the number of openings in the base 22, as, although multiple portions are defined by the cover 26, the cover is preferably made up of a single piece of material. FIG. 3 illustrates the minor portion of the cover 30 attached to the major portion of the cover 28 via an integral hinge.

As illustrated, the cover 26 is connected to the base 22. While it is desirable that the cover 26 is connected to the base 22 in a manner so as to allow the cover to pivot, it will be appreciated that any manner of connecting the cover 26 to the base 22 may be employed. In one embodiment, the cover 26 is movably attached to the base 22 by a hinge. The hinge is integrally formed with the base 22 and cover 26. It should be appreciated that any suitable hinge or hinges could be used to connect the cover 26 to the base 22. The hinge enables the cover 26 to pivot between an open position and a closed position.

In another embodiment, illustrated in FIGS. 3 and 4, the cover 26 is connected to the base 22 via a snap-fit system. According to this embodiment, the cover 26 comprises pegs 80 that project from the underside of the cover 26. Preferably, these pegs 80 project from the area at which the major portion 28 and the minor portion 30 of the cover are hinged. In the base 22 are holes 82 for receiving the pegs 80. The pegs 80 are configured to snap-fit with the holes 82, so as to attach the cover 26 to the base 22. In this embodiment the major portion 28 and minor portion 30 are still able to pivot to open or close the major 60 and minor 62 openings, respectively.

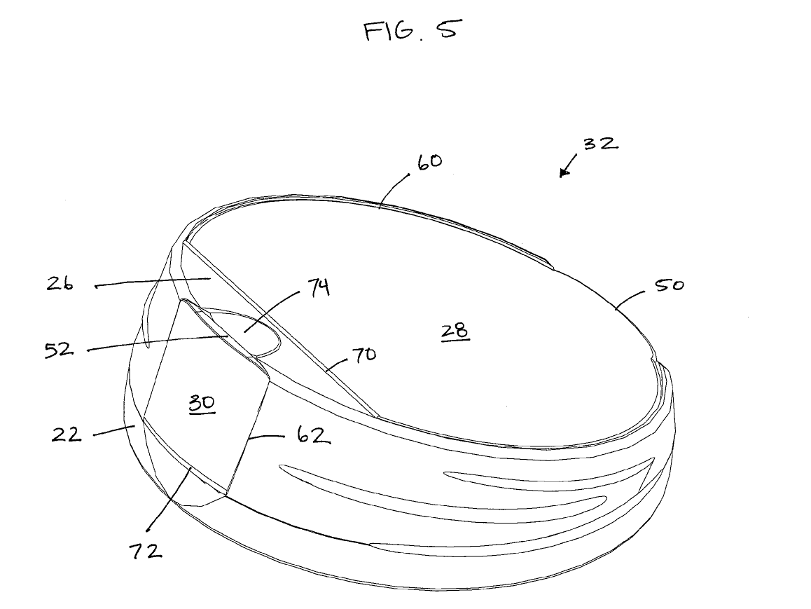

Referring now to FIG. 5, an embodiment of a one-piece lid for a consumable product container is illustrated as lid 32. Like the lid 20 shown in FIG. 1, the lid 32 also comprises a major opening 60 and a minor opening 62 arranged in separate planes of the lid. However, the lid 32 as shown in FIG. 5 does not include a separate cover piece but does include multiple covers 28, 30 which can be integrally molded with the lid 32 to cover the major 60 and minor 62 openings. In an embodiment, a minor cover 30 can open via a pivot point 72 located towards a bottom edge of the minor opening 62. Similarly, a major cover 28 can open at a pivot point 70 located towards a top edge of the major opening 60. Pivot points 70, 72 may be located along any edge of the covers 28, 30 such that the covers 28, 30 may open in any direction. An exterior surface of the lid 32 may clearly indicate in which direction the covers 28, 30 open. The pivot points 70, 72 may be living hinges but other suitable types of hinges can be used.

The minor cover 30 may secure the minor opening 62 in various ways. For example, the minor cover 30 may seal the minor opening 62 via such non-limiting examples as a plug seal, a press-fit seal, and a snap-fit seal. In an embodiment, the seal creates a popping sound when the minor cover disengages from the minor opening 62. The lid may also include one or more recesses 74 providing access to the major 28 or minor 30 covers. As shown in FIG. 5, the recess 74 can be located adjacent to a tab 50, 52 of one of the covers.

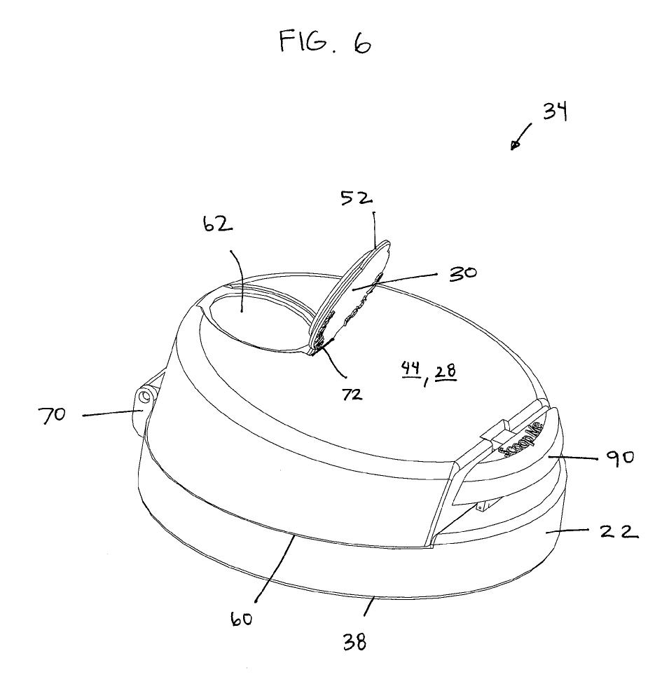

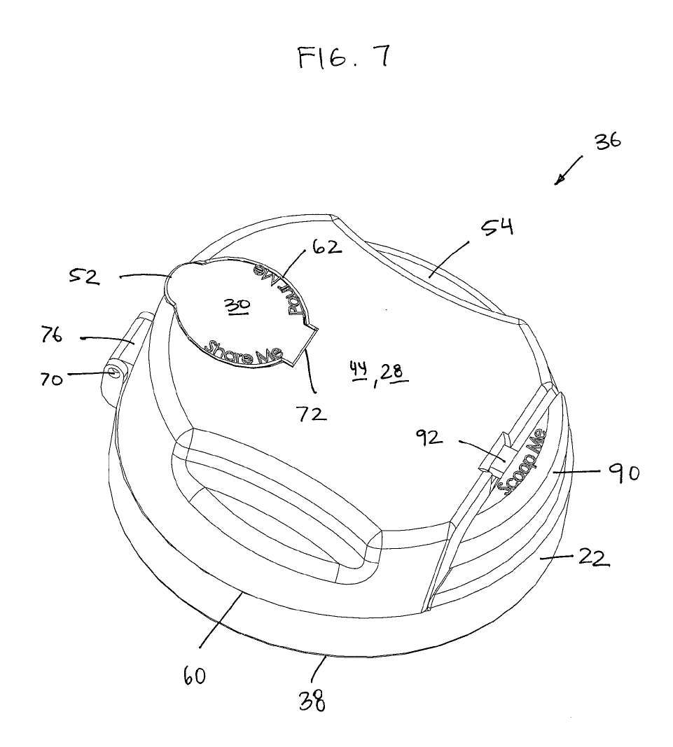

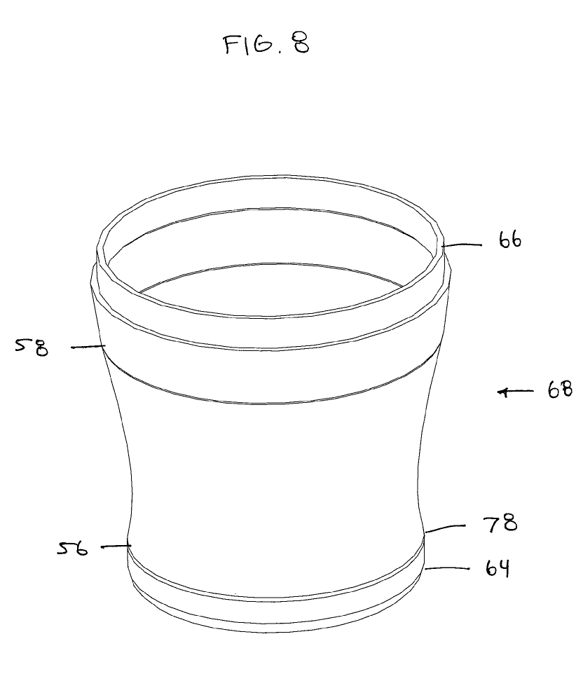

Referring now to FIG. 6 through FIG. 7, the lid 34, 36 may include a push button assembly 90 to open the major opening 60 via a pivot point 70. The pivot point 70 may involve a hinge mechanism 76. The hinge mechanism 76 may include a spring which may be made from either silicone or metal. When the push button 90 is activated, the spring may bias the major cover 28 towards an open position with respect to the base 22. To lock the major cover 28 in a closed position with respect to the base 22, the major cover 28 may engage the push button 90 at a latch closure (best shown as 92 in FIG. 8) to cover the major opening 60. The push button 90 may enable a consumer to open the container with a single press using only one hand. In an embodiment, the base 22, major cover 28, and push button 90 may be molded separately.

It should be understood that various changes and modifications to the lid embodiments discussed above and shown in FIGS. 1 though 8 will be apparent. For example, as shown in the Figures, the lid includes a top face 44 which is defined in a plane that is at an angle with respect to a horizontal plane so as to create a sloped surface. However, the top face 44 of the lid may also be defined in a plane that is parallel with respect to a horizontal plane so as to create a flat surface. In other words, the top face 44 may either be flat or sloped.

It should be appreciated that the major and minor openings 60, 62 may be found in various portions of the container. In the embodiments illustrated in FIGS. 1-5, the major opening 60 may be defined by a top face 44 of the lid, while the minor opening 62 may be defined by a side of the lid. It should be appreciated that the minor opening 62 may also be defined by the top face 44 of the lid, as shown in the embodiments of FIG. 6 through FIG. 8. In another embodiment, the minor opening 62 may be defined by the major cover 28 and the top face 44 of the lid at the same time. In a further embodiment, the major and minor openings 60, 62 may be defined by the receptacle, as discussed in detail below.

It should also be appreciated that the major 60 and minor 62 openings may lie in various planes with respect to one another and with respect to various portions of the container. For example, the openings may lie in the same plane with respect to one another (e.g. the plane of the top face 44). The minor opening 62 may also lie within the major opening 62. As discussed above, the major and minor openings 60, 62 may lie in different planes. Furthermore, as shown in FIGS. 6-8, the major opening 60 may lie in a flat plane, while the top face 44 may lie in a sloped plane. Even still, the major and minor openings 60, 62 may lie in separate but parallel planes, a variation of the lid embodiments illustrated in FIGS. 6 and 7.

An advantage of the present invention is to provide a product container that is controllable to dispense only a desired amount of product. One way of carrying out this aspect of the invention involves providing ergonomic contours 54 on the lid 36 to assist a consumer in dispensing the consumable products. In an embodiment, as shown in FIG. 7, ergonomic contours 54 in the lid may assist a consumer in pouring products from the minor opening 62 when the minor cover is in an open position. In another embodiment, the contours 54 may assist in pouring from the major opening 60. Furthermore, the contours 54 may provide an ergonomic means for the consumer to hold the container during transport.

In the present specification, as used herein the term “ergonomic contour” means a shape formed or molded along an outer periphery of a container to fit a particular portion of a consumer's hand, where the shape is designed to promote the natural orientation of a consumer's grip and to minimize the strain a consumer exerts when gripping the container by the ergonomic contours.

In addition to the lid, the container also includes a receptacle for housing the consumable products. The receptacle may be of increased capacity, providing a large amount of products to the consumer to help alleviate product outages. With the increased amount of products, a consumer may be encouraged to share the products with other consumers. The capacity of the receptacle also reduces the amount of overall packaging material required for the container with respect to the amount of product provided therein. In this way, the container may house a large amount of relatively small, solid consumable products at the same time.

Similar solid consumable products may typically be packaged into smaller packages relative to the container of the present invention. In this regard, such small packages housing similar consumable products may be placed on impulse racks near the checkout counter of a store. Alternatively, the increased size of the container of the present invention can afford similar solid consumable products with valuable shelf space within the aisles of a store. A plurality of containers of the present invention can be displayed together on aisle shelves or sold together in bulk. The entire container may be disposed or reused. Furthermore, the container may be portable so as to be ready for use in different environments. For example, the container may be suitable for use in a car, in an office, or at home.

In an embodiment, the products housed in the receptacle may be confectionery products, including such non-limiting examples as hard candies, gummy candies, mints, tablets, gum pellets, beads, liquid filled beads, chewy candy, chocolate, caramels, and gumballs. In another embodiment, the products may be snack foods, including such non-limiting examples as peanuts, nuts, pretzels, and salty snacks. In yet another embodiment, the products can alternatively be any other type of solid consumable product. For instance, the products can be cough drops or breath mints or other types of medical, consumable products. In a further embodiment, the container may include combinations of products. It should also be appreciated that the container may house non-edible products of similar size and shape.

The lid may be connected to the receptacle as discussed above (i.e. a threaded, snap-fit, or friction fit connection). This connection may provide an airtight seal between the lid and the receptacle. As shown in FIG. 2 through FIG. 4, a threaded connection 40, 42 may be used to prevent the lid from undesirably separating from the receptacle when the major 28 or minor 30 portions are forced open. The durable threaded connection may include cooperating single threads (one of 40 and 42) or double threads (40 and 42) on each of the lid and the receptacle.

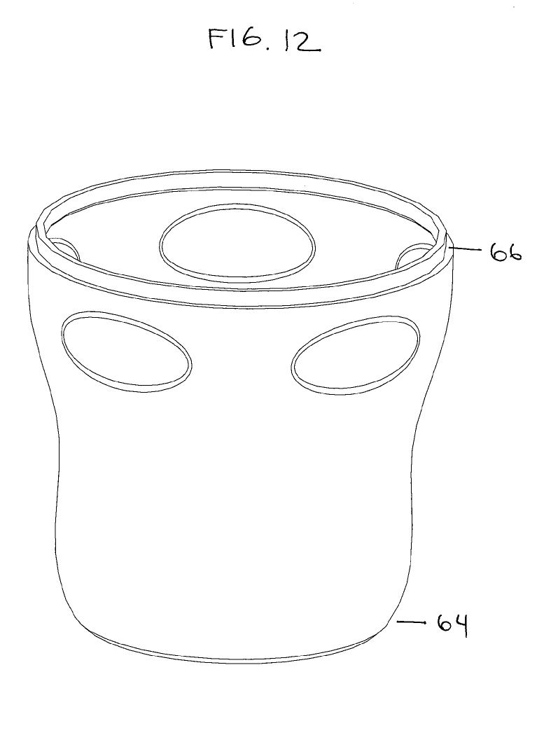

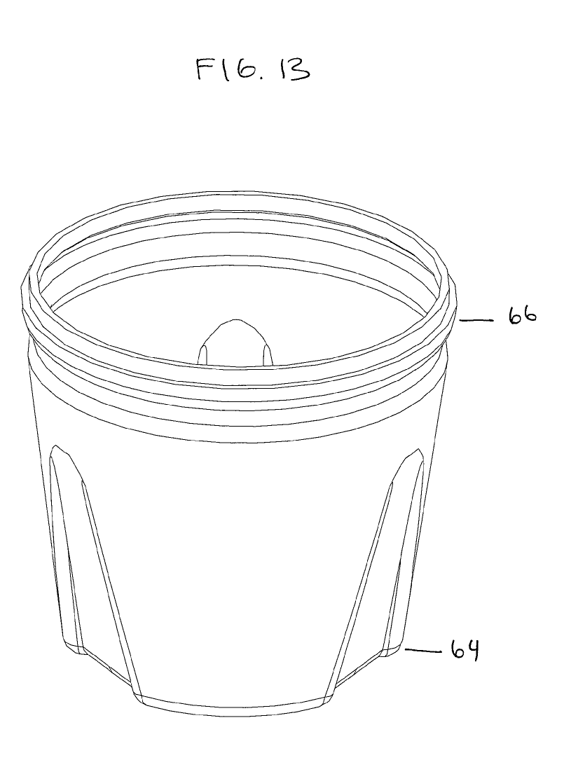

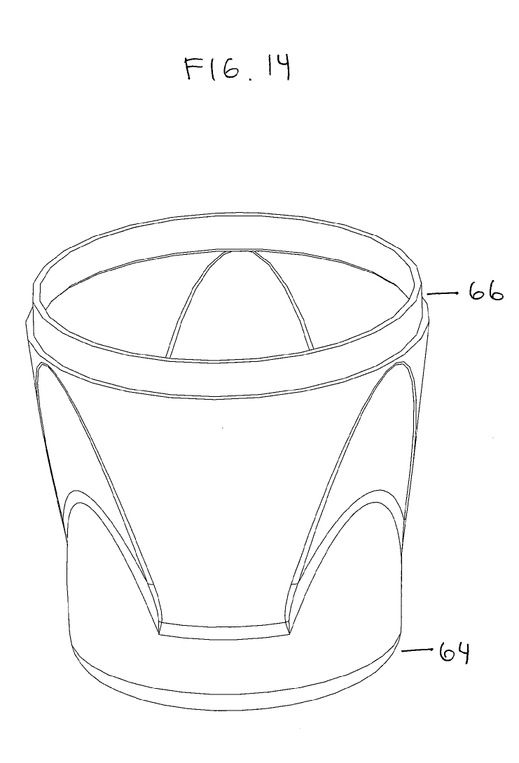

The container may also involve at least one closure assembly (e.g. sealed cover portions, hinge assemblies, push-button assemblies, etc., as discussed in further detail below) which can activate the lid or provide access to an opening in the lid. The closure assembly and the connection between the lid and the receptacle may act in concert to secure the container so the container may not open when dropped or agitated. More specifically, the container may not undesirably open when dropped from at least thirty-six inches or when agitated inside a purse or bag. Furthermore, the container may be sufficiently rigid to prevent the container from deforming or opening when squeezed. It should be appreciated that any lid embodiment discussed above may be paired with any of the receptacles shown in FIGS. 8-14 to form the consumable product container.

In an embodiment, the receptacle is sized and shaped so as to conveniently fit into a standard cup holder such as a cup holder in an automobile. The receptacle may also be sized so as to prevent the container from rattling inside the cup holder. For example, the average diameter of the receptacle may measure between about 2 inches and about 3 inches, or approximately two and a quarter inches.

In another embodiment, the receptacle may be tall enough so a consumer can grab a periphery of the receptacle with an entire hand. In other words, the height of the receptacle (i.e. from a bottom surface of the receptacle 64 to a mouth 66) may measure at least the width of an average adult palm. In an embodiment, the height of the receptacle, by itself, may measure between about 2.5 inches to about 3.5 inches. In an embodiment, the height of the receptacle may measure approximately two and three quarter inches.

In a further embodiment, the receptacle may be shallow enough so a consumer can remove the last consumable product touching the bottom surface of the receptacle without shaking or inverting the container. In other words, a consumer can reach into an interior of the container with an index finger to retrieve the last product from the bottom surface of the receptacle. In an embodiment, a consumer can extract the last consumable product from the major opening 60 in a lid 20, 32, 34, 36. Thus, the height of the container from the bottom surface of the receptacle 64 to the top face 44 of the lid may measure the length of an average adult index finger. For example, the height of container from a bottom surface 64 of the receptacle to the tallest point of the lid may measure between about 3 inches to about 4.5 inches. In an embodiment, the maximum height of the container may measure about three and a half inches.

In a further embodiment, the mouth 66 of the receptacle is sized for an average adult hand to scoop products from an interior of the receptacle. For example, the mouth 66 of the receptacle may have a diameter between about 2 inches and about 3 inches. In an embodiment, the mouth may have a diameter of about two and a half inches.

In an embodiment, the receptacle may generally be fructo-conical in shape so that the diameter of the bottom surface 64 of the receptacle may be smaller than the diameter of the mouth 66 of the receptacle. In other embodiments, the receptacle may resemble shapes including such non-limiting examples as a cylinder, a cube, a block, a pyramid, a cone, or a sphere. Furthermore, in an embodiment, the bottom surface of the receptacle may be a flat surface. In another embodiment, the bottom surface may be slightly concave towards an interior of the receptacle. If the bottom surface is slightly concave, the bottom surface may not be configured so as to constrict a consumer's access to the last piece of consumable product located within a crevice 78 of the receptacle.

The receptacle, like the lid, may also include ergonomic contours to aid a consumer in dispensing the consumable products from the container. In an embodiment shown in FIG. 8, the receptacle may include an ergonomic contour such as a tapered middle region 68. The concave curve of the taper may involve a large radius of curvature. In an embodiment, the radius of curvature of the taper may measure between about 3 inches to about 5 inches. In an embodiment, the radius of curvature of the taper measures about four inches. In other words, the taper may be gradual enough so that a single consumable product may not get stuck in a crevice 78 at the bottom surface 64 of the receptacle. Therefore, even with this tapered ergonomic design, a consumer may use an index finger to extract the last consumable product lying in the crevice 78 of the receptacle without shaking, inverting, or pouring from the receptacle.

The tapered design permits a label to surround the circumference of the receptacle in a consistent manner. The shoulders 56, 58 of the receptacle may lock the label at the middle of the receptacle, preventing the label from sliding off. In an embodiment, the label may be a pre-printed shrink wrapper or a pressure sensitive layer (e.g. sticker). In another embodiment, the label may be molded into various parts of the container.

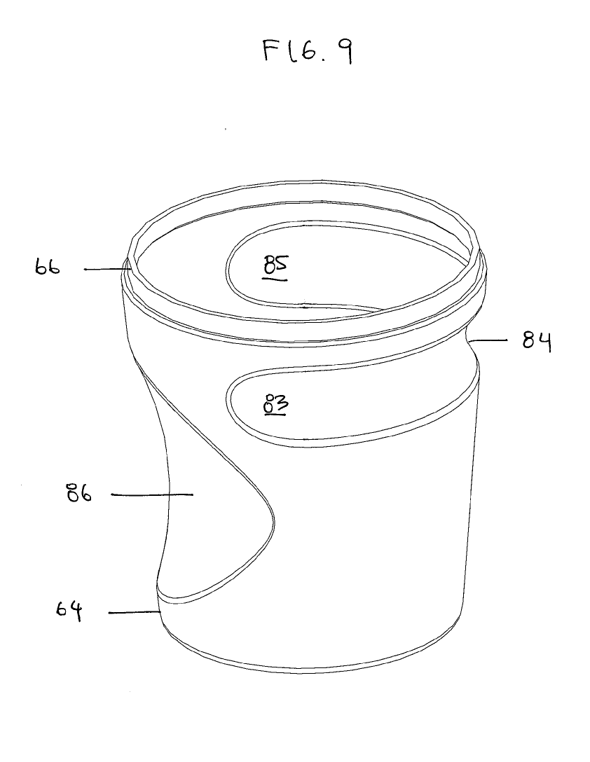

The receptacle may include more than one ergonomic contour. The ergonomic contour may include one or more thumb contours, hand contours, or separate finger contours. As shown in FIG. 9, an embodiment of the receptacle may include a first ergonomic contour 84 as well as a second ergonomic contour 86. In this embodiment, the first ergonomic contour 84 includes a thumb contour 84 which may be substantially oblong or elongate in shape and have a width of about the average adult thumb. In an embodiment, the thumb contour 84 has a width between about half an inch to about an inch, for example, about three-quarters of an inch. In an embodiment, the thumb contour 84 can stretch across at least half of the circumference of the receptacle. The thumb contour 86 may be positioned perpendicularly around the receptacle with respect to a vertical axis that passes through the center of the bottom surface.

A second ergonomic contour 86 may also be positioned perpendicularly around the receptacle with respect to the same axis. The second ergonomic contour 86 may include a hand contour or set of separate finger contours. This ergonomic arrangement illustrated by the embodiment in FIG. 9 is designed for both left- and right-handed consumers. For example, a consumer can align a left thumb with a left-handed area 83 of the thumb contour 84 and a hand with the second ergonomic contour 86. Similarly, a consumer can align a right thumb with a right-handed area 85 of the thumb contour 84 and a hand with the second ergonomic contour 86. Thus, whichever way the receptacle is positioned on a surface, a consumer can comfortably and quickly grab the receptacle from various angles utilizing the first and second ergonomic contours.

It should be appreciated that a consumer is not limited in utilizing the ergonomic contours in any specific manner. For example, a consumer can align a right or left index finger with the first ergonomic contour 84 rather than a thumb, and align his or her thumb with the second ergonomic contour 86 rather than his or her hand.

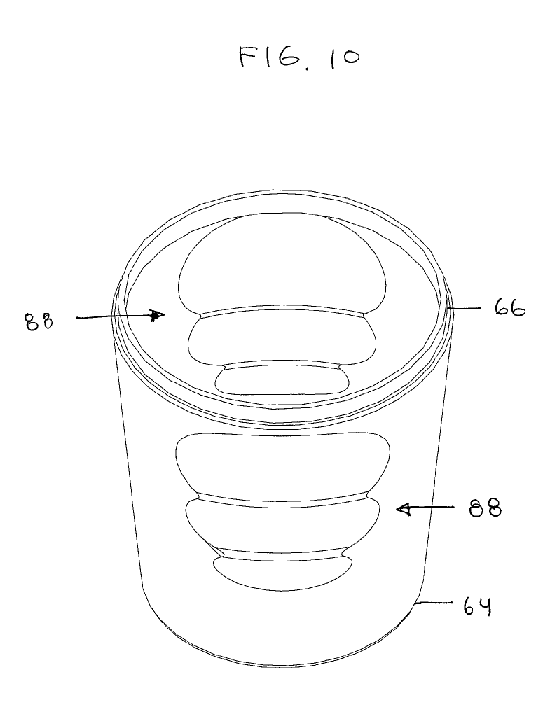

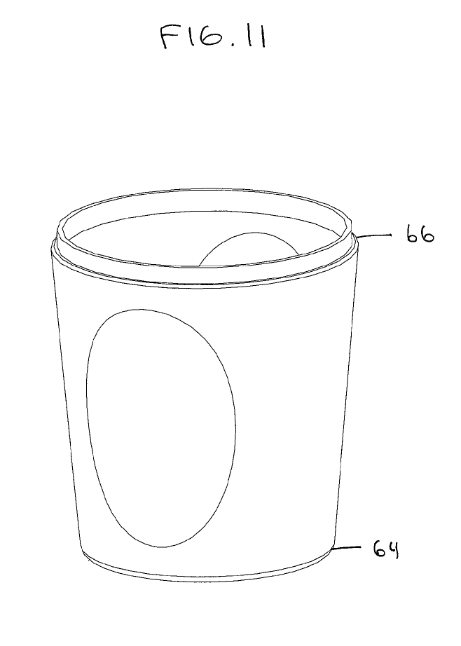

In another embodiment, as shown in FIG. 10, a receptacle may include a first contour and a second contour. In an embodiment, the first and second contours can each be a set of symmetrically disposed finger contours 88. Like the embodiment of FIG. 9, the receptacle of FIG. 10 is designed for both left- and right-handed consumers. FIG. 11 through FIG. 14 illustrate further embodiments of the receptacle having multiple ergonomic contours disposed around the circumference of the receptacle which are also designed for both left-and right-handed consumers. In yet another embodiment, (not shown) the ergonomic contours may be specifically arranged for either a left- or right-handed consumer. For example, only a left-handed area 83 or a right-handed area 85 may be provided on the thumb contour 84. In other words, only a portion of the thumb contour 84 stretching no more than half of the length of the thumb contour 84 can be disposed on the receptacle. In these examples, the thumb contour 84 would not be disposed symmetrically with respect to the second ergonomic contour 86 on the receptacle.

The receptacle may also include gripping surfaces on the exterior of the receptacle. The gripping surfaces may include a coating layer with a higher coefficient of friction than the rest of the receptacle. In an embodiment, the gripping surface is co-extruded with the receptacle. The gripping surface may be made from any suitable material capable of being extruded with and attached to the receptacle material. Alternatively, the gripping surface may involve textured regions of the receptacle. In an embodiment, gripping surfaces may be located on each ergonomic contour area. In another embodiment, gripping surfaces may be located on a single ergonomic contour area. In a further embodiment, the gripping surface may be located on at least a portion of or on an entire ergonomic contour area. In yet another embodiment, the gripping surface may be located on various other portions of the lid and the receptacle, such as on the bottom surface of the receptacle so as to provide a non-slip surface for the container.

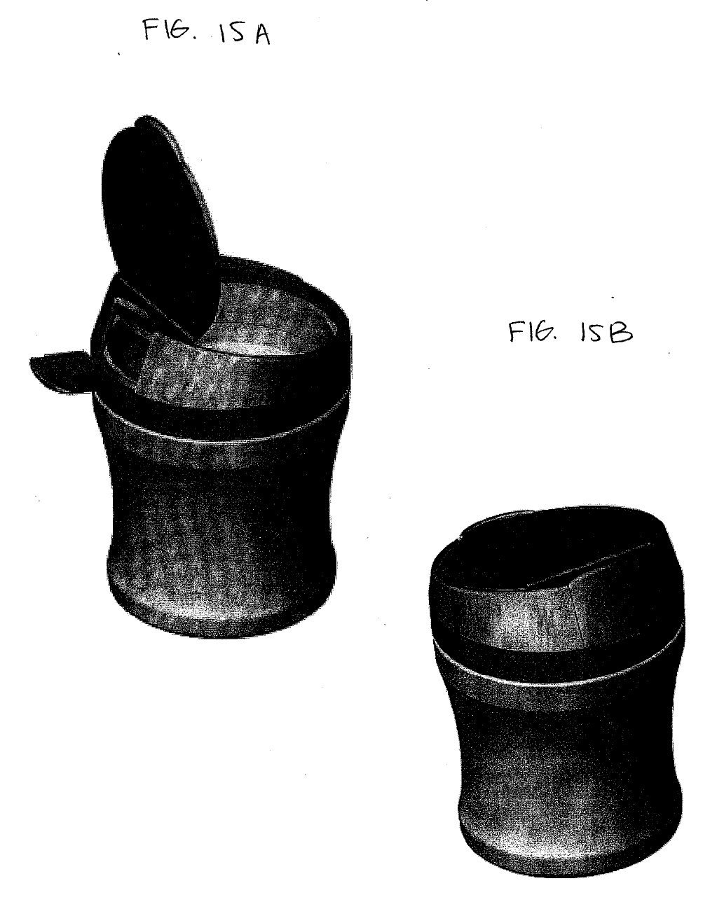

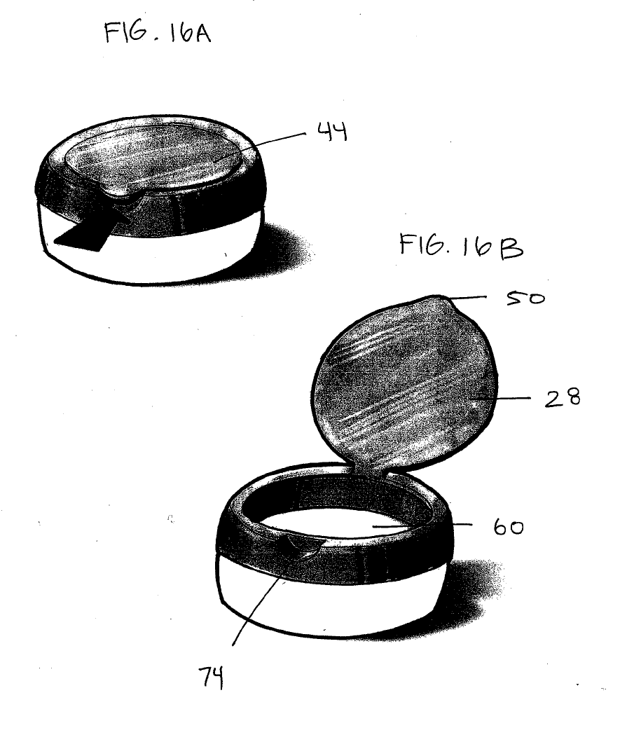

As discussed above, any lid embodiment discussed herein may be paired with any receptacle embodiment as shown in FIG. 8 through FIG. 14 to form the consumable product container. FIGS. 15A and 15B illustrate embodiments for the consumable product container made from one combination of a lid and receptacle of the present invention. However, it should be appreciated that numerous combinations exist. The consumable product container may be portable, stylish, and reusable. Furthermore, the container may make a plurality of consumable products easily accessible to the consumer in various environments. For example, the container may be placed in a home, on a desk, or in a car. FIGS. 16A-25C illustrate additional embodiments of the consumable product container.

As shown in FIGS. 16A and 16B, the container may resemble a wide-mouthed compact jar. The container may include a receptacle and a lid connected to each other as discussed above (e.g. snap-fit, threaded, friction-fit, etc.). A top face 44 of the lid may be flat and a cover portion 28 may be located in a plane that is the same as a plane of the top face. An opening 60 in the lid may provide access to a plurality of consumable products. The cover portion 28 may include a flange or tab 50 for separating the cover portion 28 from a base of the lid to provide access to the opening 60. A recess 74 may provide thumb access to an underside of the flange 50. The cover portion 28 may be hinged to a base of the lid via a living hinge. A consumer may place a thumb or finger within the recess 74 and swing the cover portion 28 open by placing a force on the flange 50 in the upward direction. This may be accomplished using a swift flicking motion.

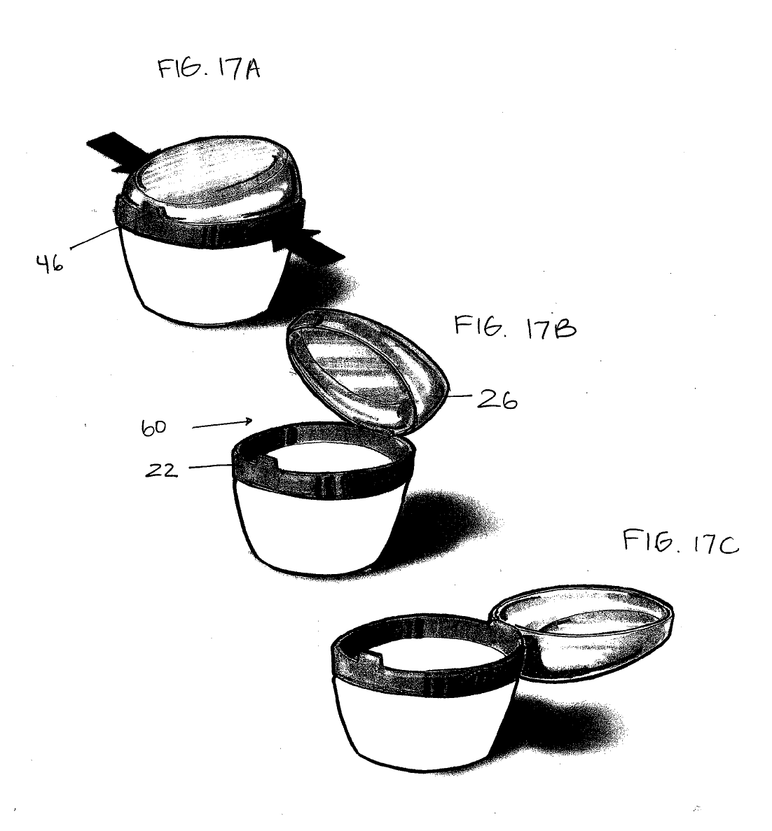

FIGS. 17A through 17C illustrate other embodiments of the consumable product container. This container may also include a receptacle and a lid connected to each other as discussed above. The receptacle may be shaped as a bowl, permitting a consumer to scoop the plurality of consumable products from an opening 60 in the lid. The lid may include a cover 26 and a base 22 where the cover is attached to the base at a spring, silicone or pivot hinge. Thus, the cover may be biased towards an open position when the spring is activated. The lid may include a closure assembly involving two diametrically opposed squeeze zones (indicated at arrows in FIG. 17A) such that a consumer may apply an inward force to the squeeze zones to pop open the cover 26. As shown in FIG. 17A, the container may also include a latch assembly 46 to lock the cover in a closed position. At least a portion of the cover or, alternatively, the entire lid, may be made from a see-through material so as to allow at least a portion of the interior to be visible through the lid.

The see-through material may consist of a PET or a PVC-type material. The see-through material may either be completely transparent or semi-transparent (i.e. translucent). The material may also be colored or frosted. The see-through portion of the lid may enable a consumer to assess the amount of remaining consumable product inside the container. It should be appreciated that at least a portion of, or an entirety of, any lid embodiment discussed herein may be made from a see-through material. It should also be appreciated that at least a portion of, or an entirety of, any receptacle embodiment may also be made from a see-through material. In an embodiment, the see-through portion of the lid may resemble a window in the lid (e.g. a transparent minor cover 30 of the embodiment in FIG. 6A, or a semi-transparent cover 28 of the embodiment in FIG. 1).

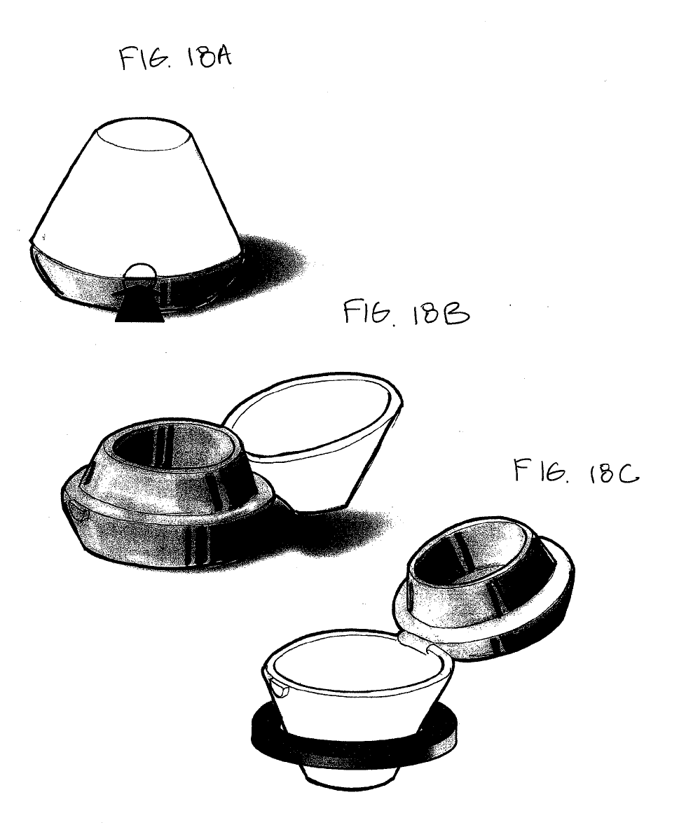

In another embodiment, the container may be designed for use in various environments. The embodiments shown in FIG. 18A and FIG. 18B illustrate a container that may be placed on a table or desk. As shown in FIG. 18C, the same container may be inverted to fit in a standard cup holder for use in an automobile. Therefore, the lid in one embodiment (FIGS. 18A and 18B) may double as a receptacle in another embodiment (FIG. 18C), and the receptacle in one embodiment (FIGS. 18A and 18B) may double as a lid in another embodiment (FIG. 18C). In other words, there may be more than one way to access the consumable products.

The container shown in FIGS. 18A through 18C defines a maximum interior volume for housing a plurality of solid consumable products. The lid has a lid interior and the receptacle has a receptacle container. The lid interior and the receptacle interior may each be capable of holding at least half of the maximum interior volume when the lid is separated from the receptacle. This way, when the container is inverted it can still hold a majority of products within an interior. In an embodiment, the receptacle and the lid are shaped differently. In another embodiment, the lid is connected to the receptacle via a hinge. In a further embodiment, a top face of the lid and a bottom surface of the receptacle each define a plane that is parallel to a horizontal plane so as to create a flat surface.

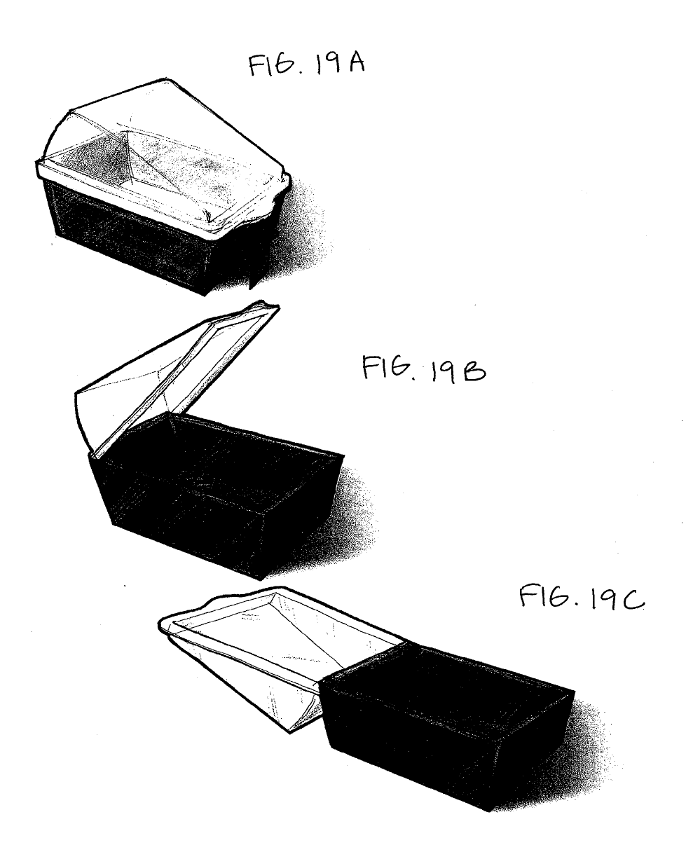

In another embodiment, the entire lid may be made from a see-through material. The embodiments of FIGS. 19A to 19C show a container with a lid and a receptacle. The entire lid may serve as a cover for the receptacle opening. In other words, the lid can be made from a single unitary piece. Furthermore, the lid may be connected to the receptacle via a hinge (e.g. spring, silicone, pivot, etc.). In an embodiment, a top face of the lid is sloped so as to create a wedge-shape in the lid. In another embodiment, a top face of the lid may be flat and parallel to the bottom surface of the receptacle (not shown). In yet another embodiment, the lid may be flat and the receptacle may be sloped or wedge-shaped. This container may also include a latch assembly (indicated at arrows in FIG. 19A) to lock the lid in a closed position. The lid may fold back to expose the interior of the container and to provide access to the opening. As discussed above, the container may be inverted so the lid may double as the cover and vice versa.

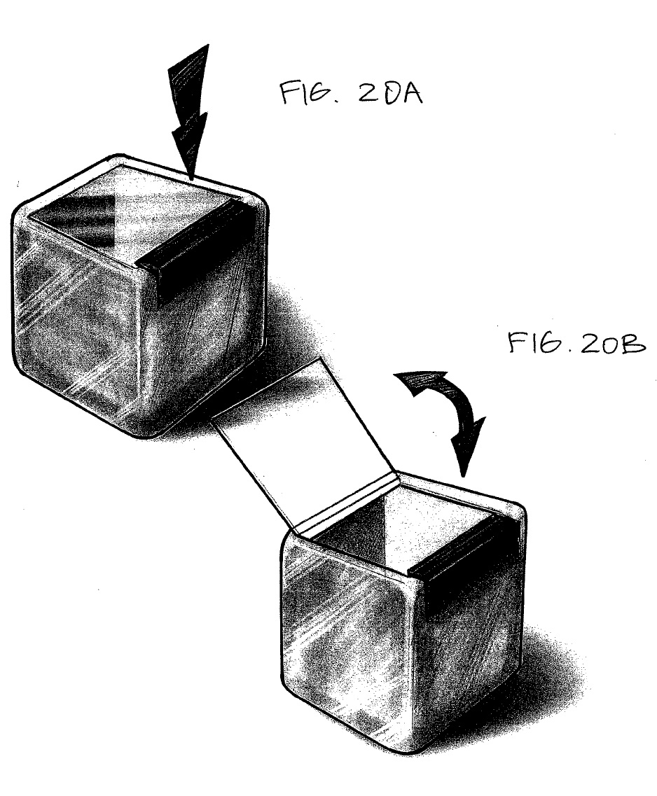

As discussed above, the receptacle may be any suitable size or shape, including a cube shape. FIGS. 20A and 20B illustrate a further embodiment of the container. As in the previous embodiment, the entire lid may serve as a cover and be made from a see-through material. The lid may be biased towards the open position with respect to the receptacle via a spring hinge or silicone hinge. The container may also include a push button closure assembly which can be depressed in a direction indicated by the arrow in FIG. 20A to release the lid from the receptacle.

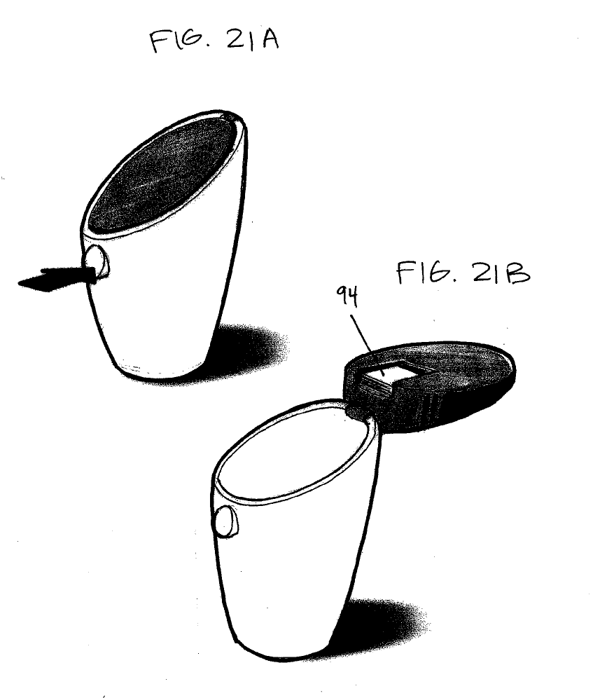

In an embodiment, the container may be used to house a plurality of chewing gum pieces. In addition, the lid may include functional aspects specifically designed for chewing gum. For example, as shown in FIGS. 21A and 21B, the lid may include a plurality of sheets 94 for disposing the gum after it has been consumed. In an embodiment, the sheets may be tissues, wax paper or foil. A stack of sheets may be disposed on an underside of the lid. In another embodiment (not shown), the receptacle may house the plurality of sheets 94 within a receptacle interior. The lid of the container shown in FIGS. 21A and 21B may be spring-biased towards an open position with respect to the receptacle.

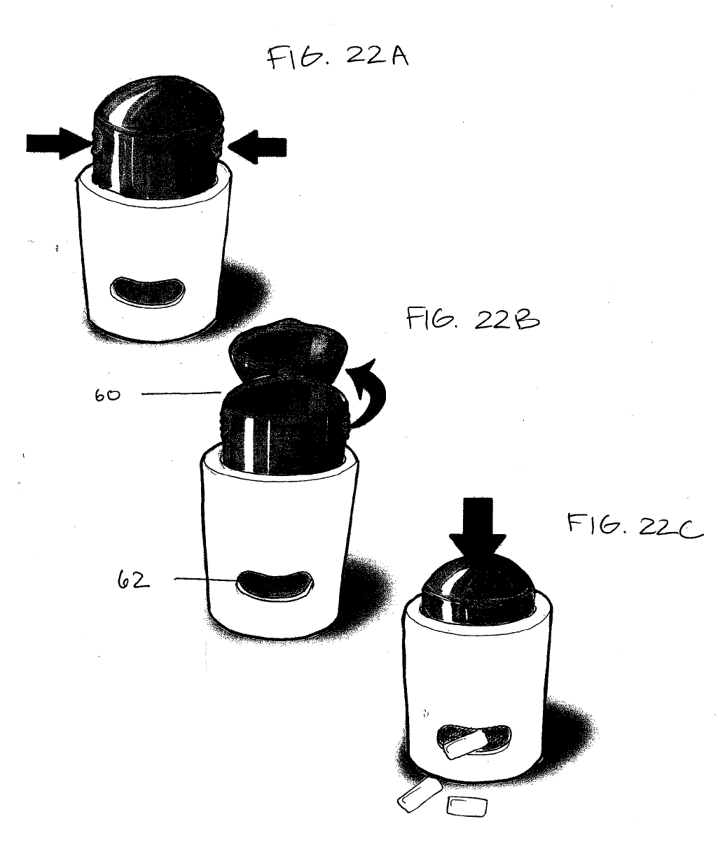

As with FIGS. 1 through 5, the container may include a larger opening 60 for individual use and a smaller opening 62 for hygienic sharing. However, the smaller opening 62 may be placed on an opposite end of the container from the larger opening 60. Moreover, the smaller opening 62 and the larger opening 60 may include two different types of closure assemblies or modes of operation. In an embodiment shown in FIG. 22A, the smaller opening 62 uses a first type of assembly, or a press-and-pop assembly, while the larger opening 60 uses a second type of assembly, or a multiple squeeze zone assembly. FIGS. 22A through 22C illustrate an embodiment where the larger opening 60 involves two diametrically opposed squeeze zones as discussed above (indicated at arrows in FIG. 22A).

In the embodiment shown in FIG. 22A, the smaller opening 62 is defined by or between both a first inner housing (darker portion) and in a second outer housing (lighter portion). The inner housing includes a lid which is spring-biased with respect to the inner housing. The inner housing is also spring biased towards a closed position with respect to the outer housing so that a smaller opening 62 in the inner housing may be blocked from a smaller opening 62 in the outer housing. Therefore, when the entire inner housing is depressed, as indicated by the arrow in FIG. 22C, the smaller openings in both the first and second housings overlap with one another to dispense a portion controlled amount of products from an interior of the container.

Although the container embodiments shown in FIGS. 15A through 15B and FIGS. 22A through 22C illustrate containers having two dispenser openings of differing sizes, it should be appreciated that any container embodiment discussed herein may include at least two dispenser openings therein. Furthermore, any container embodiment discussed herein may include a major opening for dispensing a large amount of products and a minor opening for dispensing a portion controlled amount of products from an interior of the container. Moreover, it should also be appreciated that any container embodiment discussed herein may include more than one type of closure assembly or mode of operation (e.g. push-button assembly, spring hinge, sealed cover portions, twisting connections, multiple squeeze zones, press-and-pop assembly, or pour spouts as discussed below).

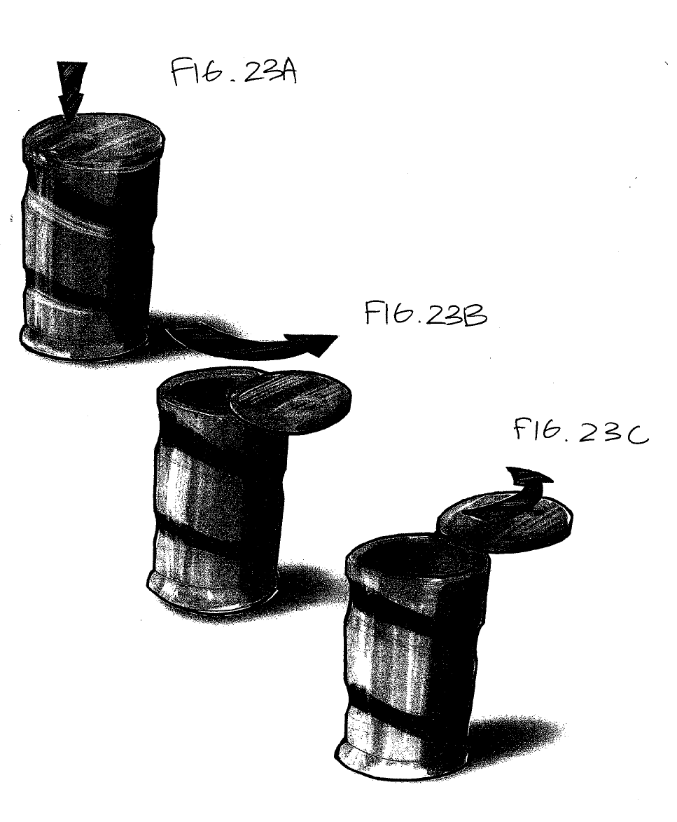

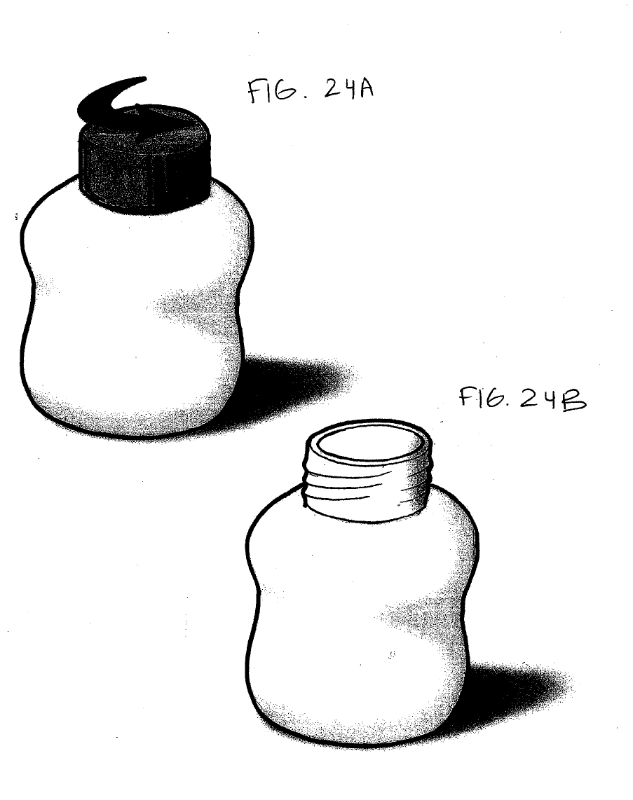

FIGS. 23A to 24B illustrate embodiments including a twisting closure assembly where a consumer may apply a twisting force to a connection between the lid and the receptacle to provide access to an opening. In an embodiment, the lid may be swiveled about an axis between an open and closed position (see FIGS. 23A to 23C). In other words, the lid may be connected to the receptacle via a swivel such that the lid turns in a circle within a horizontal plane about a pivot axis with respect to the receptacle. The pivot axis can include a headed pin connecting the lid and the receptacle such that the lid can turn or pivot about the headed pin independently from receptacle.

In another embodiment, the twisting closure assembly may include a lid which may be connected to the receptacle via threads so that a twisting force completely separates the lid from the receptacle (see FIGS. 24A to 24B). As discussed above, the receptacle may include ergonomic contours. The receptacle of FIGS. 23A to 23C shows an ergonomic contour as a peripheral coil, while the receptacle of FIGS. 24A to 24B shows an ergonomic contour as a tapered middle region as discussed above. Furthermore, the lid may include an ergonomic contour such as the thumb contour (indicated at arrow in FIG. 23A).

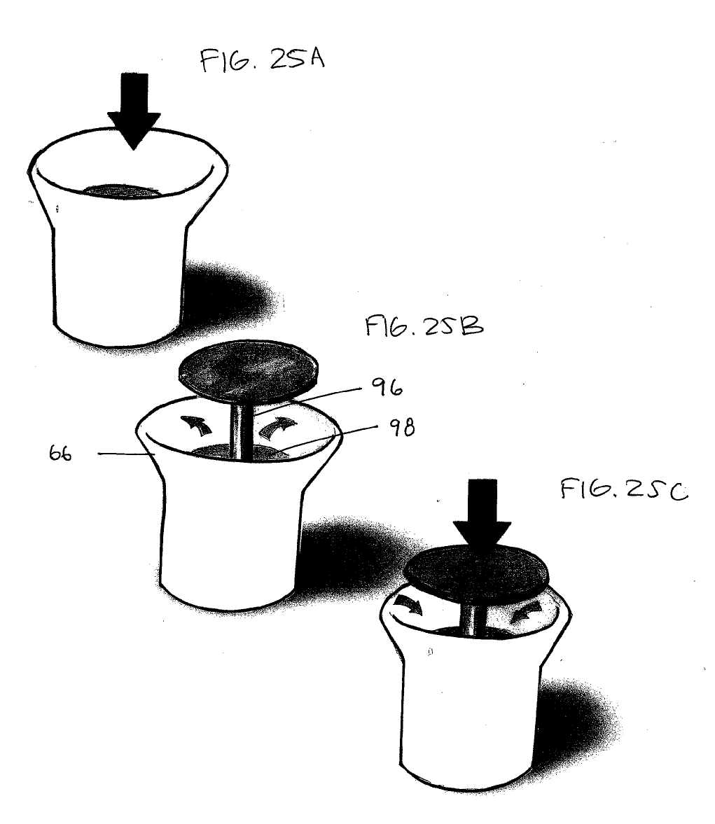

In another embodiment, the container may include a self-rise mechanism to bring the products to the consumer. As shown in FIGS. 25A to 25C, a container may include a receptacle and a moving lid which may be spring-biased with respect to the receptacle. In an embodiment, the lid may include a shaft 96 and a floor 98 designed to adjust the internal volume of the receptacle. The lid may be pressed to activate the self-rise mechanism and to lift the products towards a mouth of the receptacle. In an embodiment, the mouth 66 of the receptacle may be flared to provide a space for a consumer to reach between the lid and the mouth. This flared shape may also provide a wider space for a flow of products as the products become more accessible to the consumer when they emerge from the receptacle. In another embodiment, the mouth of the receptacle may have the same size and shape as the bottom surface of the receptacle. In yet another embodiment, the mouth of the receptacle may include one or more pour spouts or tapered portions (not shown). In a further embodiment, the receptacle may include an inner housing and the lid may include an outer housing. The inner and outer housings may act in concert with one another to provide access to a smaller opening 62 as discussed above. To close the container, the lid may be pressed again to lock the lid within the receptacle. The top face of the lid 44 may include a thumb contour (indicated at arrow in FIG. 25C) and the receptacle may include contours as well.

Although not illustrated, the container may include an induction seal. The induction seal may protect the consumable products, promote freshness, and extend the shelf life of the products. An induction liner may seal around the mouth 66 of the receptacle. When a consumer first receives the container, the consumer can either open or remove the lid before breaking the induction seal and exposing the consumable products. Conventional induction sealing techniques may be used, including such non-limiting examples as cold sealing, heat sealing utilizing a hot melt, heat activated adhesive or fusible substrate, room temperature sealing utilizing room temperature adhesives, or other induction sealing processes utilizing conductive foil systems. Alternatively, a conduction seal may be used instead. Conventional conduction sealing techniques may also be used.

The lid and the receptacle may be constructed using conventional molding processes, including such non-limiting examples as injection blow molding, extrusion blow molding, injection molding, and thermoforming. The container may be made from disposable materials. More specifically, the lid and receptacle may be made from materials including such non-limiting examples as plastic, tin, paper and combinations thereof.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A consumable product container comprising:
a receptacle comprising an interior housing a plurality of solid consumable products and an opening; and
a lid covering the opening and comprising a top face, the top face defining a plane that is at an angle with respect to a horizontal plane so as to create a sloped surface.

2. The container of claim 1 wherein the lid defines at least one opening.

3. The container of claim 1 wherein the lid defines at least two openings having different sizes.

4. The container of claim 1 wherein the receptacle is sized and shaped to fit in a standard cup holder.

5. A container comprising:
a receptacle defining an interior housing a plurality of consumable products and having an opening; and
a removable lid for covering the opening wherein at least a portion of the interior is visible through the lid.

6. The container of claim 5 wherein at least a portion of the lid is transparent.

7. The container of claim 5 wherein at least a portion of the lid is semi-transparent.

8. The container of Clam 5 wherein the entire lid is either transparent or semi-transparent.

9. The container of claim 5 wherein the receptacle is opaque.

10. The container of claim 5 wherein the receptacle comprises a portion that allows a portion of the interior to be visible through the receptacle.

11. A container comprising:
a receptacle defining an interior housing a plurality of consumable products, the receptacle including a mouth, a bottom surface, and an ergonomic contour;
a lid for removably covering the mouth and defining at least one opening; and
wherein a height of the container from the bottom surface of the receptacle to the opening in the lid measures between about 3 inches to about 4.5 inches.

12. The container of claim 11 wherein the height of the receptacle from the bottom surface to the mouth measures between about 2.5 inches and about 3.5 inches.

13. The container of claim 11 wherein the receptacle is sized and shaped to fit in a standard cup holder.

14. The container of claim 11 wherein the receptacle has a shape selected from the group consisting of cubic, rectangular, pyramidal, cylindrical, conical and spherical.

15. The container of claim 11 wherein the ergonomic contour comprises a concave taper including a radius of curvature between about 3 inches to about 5 inches.

16. The container of claim 13 wherein the receptacle has a diameter measuring between about 2 inches to about 3 inches at the mouth.

17. A method for marketing product housed in a container comprising the steps of:
providing a container including an interior housing a plurality of consumable products comprising a lid having a first opening and a second opening each for dispensing products, wherein the first opening is smaller than the second opening; and
instructing the consumer to use the first opening for sharing the consumable products with more than one consumer.

18. The method of claim 17 wherein instructions are printed on the container.

19. The method of claim 17 wherein instructions are provided in a product insert.

20. A confectionery product container comprising:
a receptacle housing a plurality of confectionery products comprising a mouth; and
a lid for removably covering the mouth and comprising at least two separate openings having different sizes and having threads so as to be removably received on the receptacle via a twisting action.

21. A consumable product container comprising:
a receptacle housing a plurality of solid consumable products comprising a mouth, the receptacle sized and shaped to fit in a standard cup holder; and
a lid for removably covering the mouth and comprising at least two separate openings.

22. A container comprising:
a receptacle housing a plurality of solid consumable products comprising a bottom surface and a first ergonomic contour, the first ergonomic contour being substantially oblong in shape, having a width between about a half inch to about an inch, and arranged and disposed perpendicularly to a vertical axis passing through a center of the bottom surface; and
a lid covering an opening in the receptacle.

23. The container of claim 22 wherein the ergonomic contour has a length of at least half of a circumference of the receptacle.

24. The container of claim 22 further including on the receptacle a second ergonomic contour disposed perpendicularly to the axis.

25. A container comprising:
a first housing and a second housing, the housings defining an interior containing a plurality of solid consumable products;
a spring biasing the first housing with respect to the second housing;
a first opening defined by the container, the first housing providing access to the interior upon activation of the spring; and
a second opening defined by one of the first housing and the second housing and providing access to the interior.

26. The container of claim 25 wherein the spring biases the first housing in a closed position with respect to the second housing.

27. The container of claim 25 wherein the spring biases the first housing in an open position with respect to the second housing.

28. The container of claim 25 wherein the second opening is larger than the first opening.

29. The container of claim 25 wherein the second opening is smaller than the first opening.

30. The container of claim 25 wherein the second opening provides access to the interior via a hinge.

31. The container of claim 25 wherein the first housing is a lid and the second housing is a receptacle.

32. The container of claim 25 wherein the first housing is an inner housing and the second housing is an outer housing.
